(19) United States
(12) Patent Application Publication
(10) Pub. No.: US 2025/0381915 A1
(43) Pub. Date: Dec. 18, 2025

(54) ADJUSTABLE STEP ASSEMBLIES FOR A TRUCK TRACTOR

(71) Applicant: Jeff D. Busby, Millsap, TX (US)

(72) Inventors: Jeff D. Busby, Millsap, TX (US); Dennis A. Schwalbe, Muenster, TX (US); Boe J. Griffith, Lipan, TX (US)

(21) Appl. No.: 19/236,739

(22) Filed: Jun. 12, 2025

Related U.S. Application Data
(60) Provisional application No. 63/660,340, filed on Jun. 14, 2024.

(51) Int. Cl. B60R 3/02; B60R 3/00

(52) U.S. Cl. CPC B60R 3/02; B60R 3/002

(57) ABSTRACT

A step assembly for a truck tractor of a tractor trailer is designed to accommodate a wide range of chassis designs from different manufacturers while still providing interior access for fuel or diesel exhaust fluid tanks. The step assembly has a first frame attached to the chassis and a second frame supporting the outer shell assembly with step plates. A hinge assembly is adjustably positioned at different (preselected) longitudinal locations along the hinge access and pivotally engages the second frame to the first frame, so the steps are movable between open and closed positions. The hinge assembly can further be vertically adjusted using uprights attached to the first frame. The first frame can further be horizontally adjusted along the chassis using releasable mounting blocks. The invention may provide a paired step assemblies with front and back running boards having similar constructions but sharing a subframe, with independent opening/closing.

### BACKGROUND OF THE INVENTION

### Field of the Invention

The present invention generally relates to step assemblies for vehicles, and more particularly to adjustable step assemblies for truck tractors.

### Description of the Related Art

Trucks and other utility vehicles typically have step assemblies or running boards allowing a driver or passenger to reach elevated seating. In a truck tractor, the seating is even more elevated well above a roadway surface so it is often necessary to provide two levels of steps to enter the cab portion of the body of the truck tractor.

### SUMMARY OF THE INVENTION

The present invention in at least one embodiment is generally directed to an adjustable step assembly for engagement with a truck tractor unit having a body engaging a chassis, the adjustable step assembly including a first frame capable of engagement with a chassis member of the chassis of the truck tractor unit, an outer assembly with at least one step plate and a shell, a second frame for engaging the outer assembly, and a hinge assembly having a hinge member with a hinge axis, for pivotably engaging the first frame to the second frame such that the second frame may move between a closed position wherein the shell conforms to the body and the steps provide access to a door of the truck tractor unit to an open position wherein the adjustable step assembly provides access to the chassis. The first frame member can be adjustably engaged to the chassis member. The assembly can further include clamp assemblies for releasably coupling the first frame to the second frame when in the closed position. In the illustrative embodiment, the hinge assembly is adapted to be vertically adjustably mounted to the first frame assembly.

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1 is a perspective view of an adjustable step assembly for engagement with a chassis member of the chassis of a truck tractor unit in accordance with one implementation of the present invention;

FIG. 2 is an exploded perspective view of the adjustable step assembly of FIG. 1;

FIG. 3 is a perspective view of an outer assembly for use with the adjustable step assembly of FIG. 1 in accordance with one implementation of the present invention;

FIG. 4 is an exploded perspective view of the outer assembly of FIG. 3; and

FIG. 5 is a perspective view of an adjustable step assembly having front and back running boards in accordance with one implementation of the present invention.

The use of the same reference symbols in different drawings indicates similar or identical items.

### DESCRIPTION OF THE PREFERRED EMBODIMENT(S)

Chassis for truck tractors are built by a number of manufacturers. The chassis usually have fuel tanks and diesel exhaust fluid (DEF) tanks engaged to chassis members. The chassis will also have a body attached thereto as well as engines and drivetrains for engagement to chassis members. Steps are usually built into the body skin, indented in some manner so that one's foot can be placed on the step and weight can be placed on the foot to support a person climbing into the cab.

The skin itself, as part of the body, will typically hide chassis members or chassis components such as fluid tanks. However, the position of the fluid receptacles that are attached to a chassis member or other chassis components attached to chassis members may vary in their position with respect to the chassis members. That is to say, when a manufacturer of custom body work for a truck manufacturer, for example Peterbilt, receives a truck tractor, the position of the fluid tanks with respect to the chassis members in the body may differ longitudinally from one chassis to the next. As a result the custom manufacturer is faced with the possibility of having to form a number of skins as part of the customization of a body, even though the tractor trailer is from the same manufacturer.

Applicant has recognized that adjustability of a body portion (or shell) of a step assembly with respect to the truck tractor chassis members that support such body portion of the step assembly may overcome the need for preparing custom body sections for each position or size variation of a given manufacturer's chassis components such as fluid tanks.

The following embodiments and variations thereof, provide adjustability of a body portion or shell of a step assembly with respect to the chassis of a truck tractor.

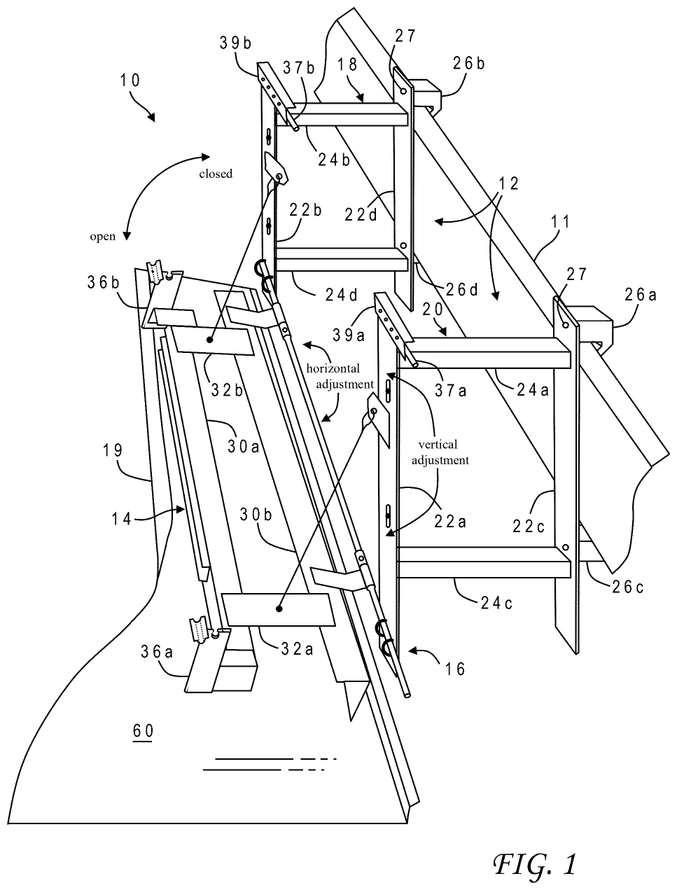

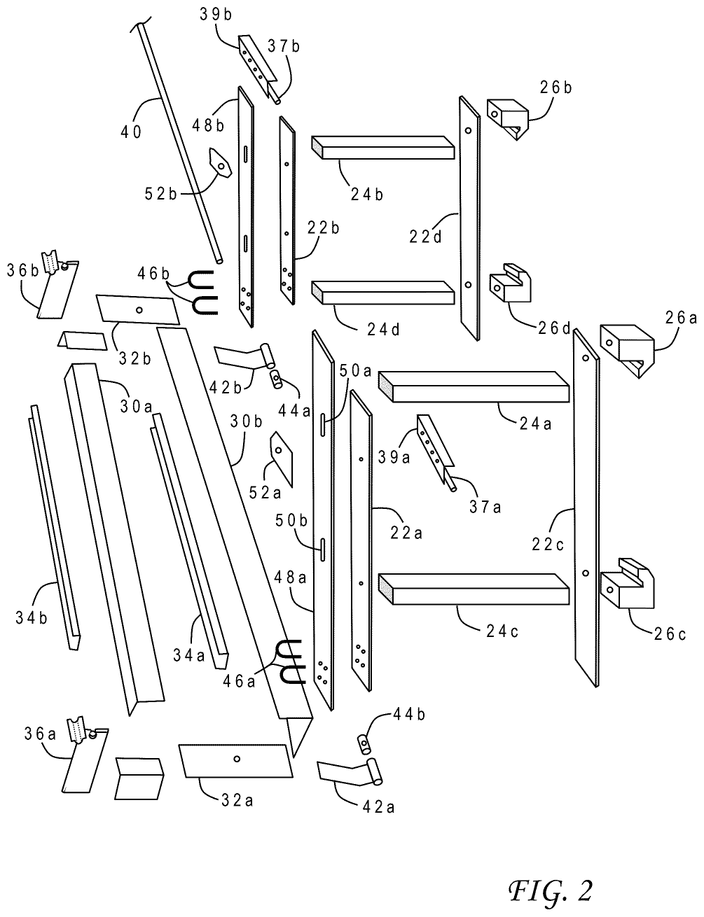

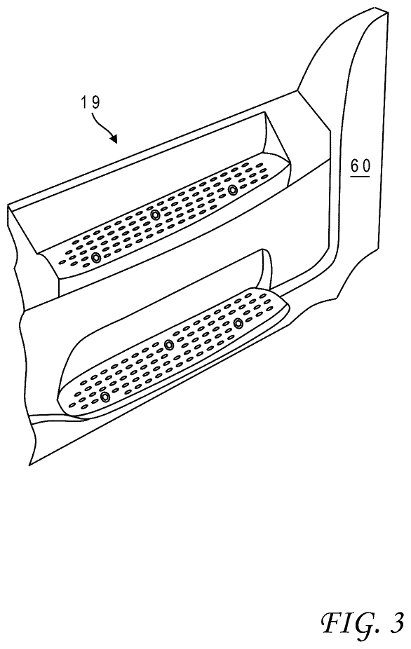

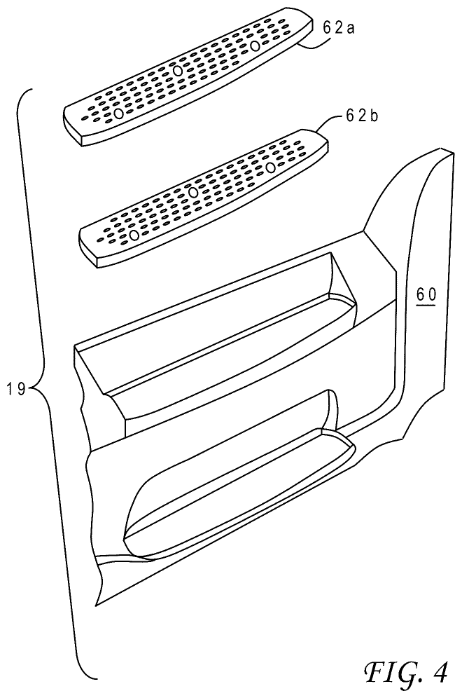

FIGS. 1 and 2 illustrate an adjustable step assembly 10 for engagement with a truck tractor unit of a tractor trailer, such as a semi, the truck tractor unit having a body, which typically includes a cab and steps for getting into the cab, which engages the chassis 11. The adjustable step assembly 10 includes at least one step plate 62 laying adjacent a shell 60 as seen in FIGS. 3 and 4, where outer assembly 19 is in a vertical orientation corresponding to the closed position, obscuring the interior features of step assembly 10. In this closed position, shell 60 conforms to exterior shape of the body of the truck tractor adjacent thereto, and the steps lead to a door of the truck tractor. FIGS. 1 and 2 shows the adjustable step assembly in the open position which provides access to the chassis.

The shell may be part of the outer skin of a truck tractor body and the entire adjustable step assembly functions to attach the shell, and the step or steps to a chassis member so that it can handle a person's weight. Moreover the shell with the step plates on the shell is designed to be adjustably located, as part of the adjustable step assembly, to a chassis member of the truck tractor unit.

The adjustable step assembly is comprised of a first frame 12, a second frame 14, an outer assembly 19 which includes the step and shell, and engages the second frame 14 and a hinge assembly 16 which hingeably engages the first frame to the second frame.

The first or inner frame 12 is adjustably engaged to a chassis member. First frame 12 may include a pair of similarly dimensioned subframes 18 and 20. As viewed from the outside of the truck tractor, back subframe 18 is positioned to the left and front subframe 20 is positioned to the right. Here, each of the two rectangular subframes has a pair of vertical members 22a, 22b, 22c and 22d. Each of the subframes also has a pair of horizontal members 24a, 24b, 24c and 24d. The subframes also include upper 26a and 26b and lower 26c and 26d attachment blocks for engaging members 22c and 22d at or near removed ends thereof, with fasteners 27. It is seen that the blocks have a groove for receiving a lip of chassis members (which typically have channel cross sections), such that when fasteners 27 are tightened down they will attach the subframes securely to the chassis member, and the fasteners can be loosened so the entire assembly can be moved left or right as seen in the figures, that is, longitudinally (laterally) with respect to the chassis member. In this manner horizontal adjustability of first frame 12 with respect to the chassis 11 is achieved so as to horizontally position first frame 12 thereupon. Alternative attachment block designs may be employed for other chassis constructions.

The various structural members comprising the frames may be attached via any convenient means. For example, vertical members 22a and 22c are welded to horizontal members 24a and 24c while vertical members 22b and 22d are welded to horizontal members 24b and 24d.

The figures also illustrate a second or outer frame 14 which includes a top longitudinal member 30a and the bottom longitudinal member 30b. FIGS. 1 and 2 show front and rear vertical members 32a and 32b attached to longitudinal members 30a, 30b and maintaining them in a spaced relationship. Channel sections 34a and 34b (FIG. 2) as well as clamp assemblies 36a and 36b are also illustrated. The clamp assemblies may be slam clamps and are conveniently located at, on, or near the removed ends of longitudinal member 30a. In the closed position of adjustable step assembly 10, clamps 36a and 36b engage arms 37a and 37b as set forth in more detail below. Outer shell 60 is bolted to second frame 14, underneath steps 62a and 62b. The steps are then bolted to the combination of shell 60 and second frame 14.

As used herein, the terms “vertical” and “horizontal”, as well as other spatial and reference terms (top, bottom, left, right, front, forward, rear, back, low, high, inner, outer, etc.), are relative since there may be situations where a particular structural member or surface may not be perfectly vertical or horizontal, may be based on a particular construction and perspective, or may be adapted for special circumstances, and even the chassis may not be horizontal per se. Those skilled in the art will accordingly understand that these terms are not used in an absolute sense and should thus not be considered as limiting the exact geometry of any of the components of step assembly 10.

Hinge assembly 16 adjustably engages first frame 12 to second frame 14 which allows outer assembly 19 to pivot between the open and closed positions. The hinge assembly comprises a rigid cylindrical rod or axle 40. The axle is entrained upon a pair of hinges 42a and 42b. Longitudinally inside of the two hinges and surrounding axle 40 are cylindrical positioning sleeves 44a and 44b which include set screws (not shown). A pair of U-bolts 46a and 46b at either end of the axle attach the axle to a pair of uprights 48a and 48b, the uprights each having a pair of adjustment slots 50a and 50b which receive fasteners (e.g., bolts) to adjustably fasten the uprights 48a and 48b rigidly against vertical members 22a and 22b at a preselected vertical position with respect to the chassis member to which first frame 12 is attached. In this manner vertical adjustability of second frame 14 with respect to first frame 12 is achieved so as to vertically position outer assembly 19 and shell 60 thereupon with respect to the chassis of the truck tractor unit. Wires may be attached to front and rear vertical members 32a and 32b at one end and to anchor plates 52a, 52b attached to uprights 48a and 48b at the other end, to limit the open (downward) position of the step assembly.

Horizontal adjustability of second frame 14 may be further achieved by loosening set screws to allow the hinges to move along the axle which defines the hinge axis. Note arms 37a and 37b are attached to adjustable brackets 39a and 39b which may be attached at a number of lateral positions with respect to the upper ends of uprights 48a and 48b to achieve alignment of the clamps when the assembly is in the closed position which rotates the shell upwardly to bring the surface of the step(s) to a horizontal position for use.

Due to the adjustability of the assembly, alignment of the shell with the rest of the body is achieved. Furthermore the two subframes may span a fluid tank as they are supported spaced apart by the axle and the chassis member itself, and the use of the U-bolts holding the axle with the attachment blocks capable of being loosened make the span itself adjustable in width to accommodate chassis components that the first frame must straddle, overcoming previous problems with tank placement interfering with step location.

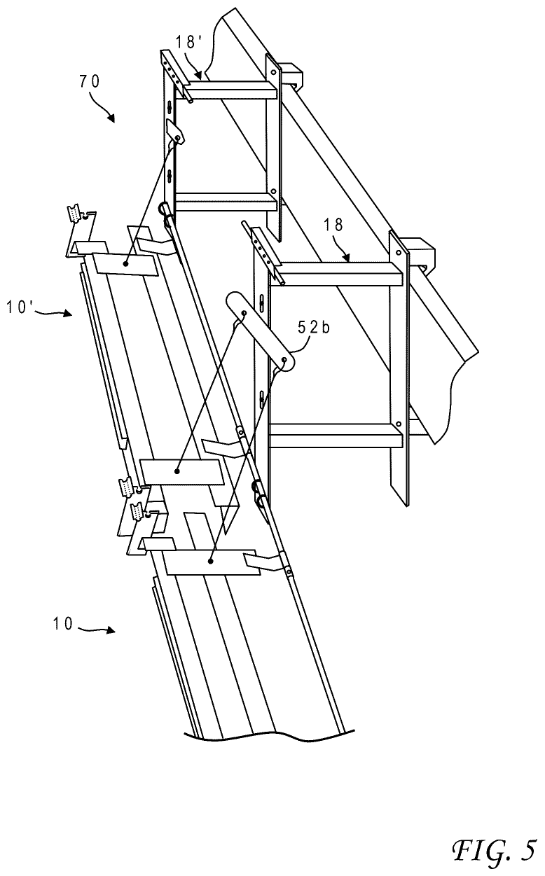

With further reference to FIG. 5, there is depicted a paired step assembly 70 which includes a front step assembly having all of the features of step assembly 10, plus a back step assembly 10′. Back step assembly 10′ is essential identical to front step assembly 10, having a first frame connected to the chassis in the same horizontally adjustable manner, and a second frame which is hinged to the first frame. However, rather than having a total of four vertical subframes, the subframe 18 of front step assembly 10 also acts as a subframe for back step assembly 10′, i.e., this is a common subframe shared by both the front and back running boards, Anchor plate 52b may also be modified to similarly be shared for anchoring wires from both front step assembly 10 and back step assembly 10′. Instead of having a second vertical subframe 18′ at the back end, back step assembly can be attached a plate of the truck battery box (not shown), i.e., U-bolts can fasten that end of the hinge rod 40 to the bottom of the truck battery box and the slam clamp at that back end can engage an arm of a bracket attached to the top of the truck battery box. Separate outer assemblies (that is, separate shells 60 and steps 62) are provided for each step assembly 10, 10′, so they can be independently opened and closed.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, while the invention has been described in the context of a truck tractor, it is equally applicable to other situations such as passenger vehicles, recreational vehicles, travel trailers, flying cars, etc. It is therefore contemplated that such modifications can be made without departing from the spirit or scope of the present invention as defined in the appended claims.

What is claimed is:

1. A step assembly for engagement with a vehicle, the vehicle having a body with a chassis, the step assembly comprising:
a first frame capable of engagement with a chassis member of the chassis of the vehicle;
an outer assembly including a shell having at least one step plate;
a second frame supporting said outer assembly; and
a hinge assembly pivotably engaging said first frame to said second frame such that said second frame may move between a closed position and an open position, said hinge assembly adapted to be adjustably positioned at a preselected location along a hinge axis of said hinge assembly.

2. The step assembly of claim 1 wherein said first frame is adjustably engaged to the chassis member.

3. The step assembly of claim 2 wherein the chassis member is horizontally oriented, and said first frame is horizontally adjustable along the chassis member.

4. The step assembly of claim 2 wherein said hinge assembly is vertically adjustably mounted to said first frame assembly.

5. The step assembly of claim 2 wherein said first frame is adjustably engaged to the chassis member using a plurality of attachment blocks that are releasably secured to the chassis member.

6. The step assembly of claim 1 further including one or more clamp assemblies for releasably coupling said first frame to said second frame when in the closed position.

7. The step assembly of claim 6 wherein:
said one or more clamp assemblies clamp onto one or more respective arms affixed to one or more respective brackets when said second frame is in the closed position; and
said one or more brackets may be attached to said first frame at a plurality of lateral positions.

8. The step assembly of claim 1 wherein said hinge assembly is vertically adjustably mounted to said first frame assembly.

9. The step assembly of claim 1 wherein said outer assembly is a first outer assembly which, together with said second frame, forms a first running board, and further comprising a second running board having a third frame supporting a second outer assembly, wherein said hinge assembly pivotably engages said first frame to said third frame such that said third frame may move between a closed position and an open position independent of movement of said second frame.

10. An adjustable step assembly for pivotable engagement with a truck tractor unit of a tractor trailer, the truck tractor unit having a body with a chassis, the adjustable step assembly comprising:
a first frame having at least front and back subframes, each of said front and back subframes being generally rectangular and including a respective chassis-side vertical member and a respective exterior-side vertical member;
mounting blocks attached to said chassis-side vertical members, adapted to engage a chassis member of the chassis of the truck tractor unit;
an outer assembly with at least one step plate and a shell;
front and back uprights each a having an upper end and a lower end, said front upright being fastened against said exterior-side vertical member of said front subframe and said back upright being fastened against said exterior-side vertical member of back subframe;
a second frame having at least a top longitudinal member and a bottom longitudinal member maintained in spaced relationship, supporting said outer assembly; and
a hinge assembly having a hinge axle attached to said bottom longitudinal member and pivotally supported by said front and back uprights at said lower ends thereof such that said second frame may move between a closed position wherein said shell conforms to the body and the step plate provides access to a door of the truck tractor unit to an open position wherein the adjustable step assembly provides access to the chassis, said hinge axle being adjustably positioned at a preselected longitudinal location.

11. The adjustable step assembly of claim 10 wherein said mounting blocks are adjustably engaged to the chassis member to allow horizontal adjustment of said first frame along the chassis member.

12. The adjustable step assembly of claim 10 wherein said uprights are vertically adjustably fastened to said vertical members of said front subframe.

13. The adjustable step assembly of claim 10 further comprising a front clamp attached to a front end of said top longitudinal member and a back clamp attached to a back end of said bottom longitudinal member, where said front and back clamps releasably couple said second frame to said first frame when in the closed position.

14. The adjustable step assembly of claim 13 further comprising:
a front bracket attached to said upper end of said front upright at one of a plurality of available lateral positions;
a front arm supported by said front bracket;
a back bracket attached to said upper end of said back upright at one of a plurality of available lateral positions; and
a back arm supported by said back bracket;
wherein, when said second frame is in the closed position, said front clamp releasably engages said front arm and said back clamp releasably engages said back arm.

15. The adjustable step assembly of claim 10 wherein said outer assembly is a first outer assembly which, together with said second frame, forms a first running board, and further comprising a second running board having a third frame supporting a second outer assembly, wherein said hinge axle is further attached to a longitudinal member of said third frame such that said third frame may move between similar open and closed positions independent of movement of said second frame.

16. An adjustable step assembly for a truck tractor of a tractor trailer, the truck tractor unit having a body with a chassis, the adjustable step assembly comprising:
a first frame having at least front and back subframes, each of said front and back subframes being generally rectangular and including a respective chassis-side vertical member and a respective exterior-side vertical member;
mounting blocks attached to said chassis-side vertical members, adapted to adjustably engage a chassis member of the chassis of the truck tractor unit to allow horizontal adjustment of said first frame along the chassis member;
an outer assembly with at least one step plate and a shell;
front and back uprights each a having an upper end and a lower end, said front upright being vertically adjustably fastened against said exterior-side vertical member of said front subframe and said back upright being vertically adjustably fastened against said exterior-side vertical member of back subframe;
a second frame having at least a top longitudinal member and a bottom longitudinal member maintained in spaced relationship, supporting said outer assembly;
a hinge assembly having a hinge axle attached to said bottom longitudinal member and pivotally supported by said front and back uprights at said lower ends thereof such that said second frame may move between a closed position wherein said shell conforms to the body and the step plate provides access to a door of the truck tractor unit to an open position wherein the adjustable step assembly provides access to the chassis, said hinge axle being adjustably positioned at a preselected longitudinal location;
a front clamp attached to a front end of said top longitudinal member;
a back clamp attached to a back end of said bottom longitudinal member;
a front bracket attached to said upper end of said front upright at one of a plurality of available lateral positions;
a front arm supported by said front bracket;
a back bracket attached to said upper end of said back upright at one of a plurality of available lateral positions; and
a back arm supported by said back bracket;
wherein, when said second frame is in the closed position, said front clamp releasably engages said front arm and said back clamp releasably engages said back arm.
